(19) United States
(12) Patent Application Publication
(10) Pub. No.: US 2026/0006037 A1
(43) Pub. Date: Jan. 1, 2026

(54) SYSTEMS AND METHODS FOR USING ARTIFICIAL INTELLIGENCE FOR FRAUD DETECTION USING AN ENUMERATION DETECTION SYSTEM

(71) Applicant: Fidelity Information Services, LLC, Jacksonville, FL (US)

(72) Inventors: Matthew HEATH, Cincinnati, OH (US); Robert BERGELT, Hebron, KY (US)

(21) Appl. No.: 18/754,586

(22) Filed: Jun. 26, 2024

(51) Int. Cl. H04L 9/40

(52) U.S. Cl. CPC H04L 63/1416

(57) ABSTRACT

A method for discontinuing interaction processing using an enumeration detection system may include receiving data associated with a plurality of interaction instances. The plurality of interaction instances may be associated with an entity. The method may further include extracting one or more interaction features from the data. The method may further include providing the one or more interaction features to a determinative machine-learning model. The determinative machine-learning model may be trained to identify enumeration patterns and output an enumeration score based on the identified enumeration patterns. The method may further include determining that the enumeration score exceeds a predetermined threshold. The method may further include discontinuing interaction processing for the entity based on the enumeration score exceeding the predetermined threshold.

### TECHNICAL FIELD

Various embodiments of this disclosure relate generally to artificial intelligence and machine-learning-based techniques for fraud detection.

### BACKGROUND

Administrators of institutions that manage client accounts may face challenges in analyzing and acting on data related to the accounts. In some cases, such institutions, and the clients they serve, may risk exposure because of fraudulent activity and the like.

Unless otherwise indicated herein, the materials described in this section are not prior art to the claims in this application and are not admitted to be prior art, or suggestions of the prior art, by inclusion in this section.

### SUMMARY OF THE DISCLOSURE

In one aspect, an exemplary embodiment of a method for discontinuing interaction processing using an enumeration detection system may include receiving data associated with a plurality of interaction instances. The plurality of interaction instances may be associated with an entity. The method may further include extracting one or more interaction features from the data. The method may further include providing the one or more interaction features to a determinative machine-learning model. The determinative machine-learning model may be trained to identify enumeration patterns and output an enumeration score based on the identified enumeration patterns. The method may further include determining that the enumeration score exceeds a predetermined threshold. The method may further include discontinuing interaction processing for the entity based on the enumeration score exceeding the predetermined threshold.

In another aspect, an exemplary embodiment of a system for discontinuing interaction processing may include a memory storing instructions and a determinative machine-learning model. The system may also include a processor operatively connected to the memory and configured to execute the instructions to perform operations. The operations may include receiving data associated with a plurality of interaction instances. The plurality of interaction instances may be associated with an entity. The operations may further include extracting one or more interaction features from the data. The operations may further include providing the one or more interaction features to the determinative machine-learning model. The determinative machine-learning model may be trained to identify enumeration patterns and output an enumeration score based on the identified enumeration patterns. The operations may further include determining that the enumeration score exceeds a predetermined threshold. The operations may further include discontinuing interaction processing for the entity based on the enumeration score exceeding the predetermined threshold.

In another aspect, a non-transitory machine-readable medium may store instructions that, when executed by one or more processors, may cause an enumeration detection system to perform a method for discontinuing interaction processing. The method may include receiving data associated with a plurality of interaction instances. The plurality of interaction instances may be associated with an entity. The method may further include extracting one or more interaction features from the data. The method may further include providing the one or more interaction features to a determinative machine-learning model. The determinative machine-learning model may be trained to identify enumeration patterns and output an enumeration score based on the identified enumeration patterns. The method may further include determining that the enumeration score exceeds a predetermined threshold. The method may further include discontinuing interaction processing for the entity based on the enumeration score exceeding the predetermined threshold.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts an exemplary environment for discontinuing interaction processing using an enumeration detection system, according to one or more embodiments.

FIG. 2 depicts a data flow diagram of an exemplary enumeration detection system, according to one or more embodiments.

FIG. 3 depicts a table of exemplary data of a client interaction processing account, according to one or more embodiments.

FIG. 4 depicts a diagram of an exemplary method for discontinuing interaction processing using an enumeration detection system, according to one or more embodiments.

FIG. 5 depicts a flow diagram for training a machine-learning model, according to one or more embodiments.

FIG. 6 depicts an example of a computing device, according to one or more embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION

Various aspects of the present disclosure relate generally to artificial intelligence and machine-learning-based techniques for fraud detection using an enumeration detection system, and more particularly to discontinuing interaction processing using the enumeration detection system. Machine-learning and/or artificial intelligence models may be used for identifying patterns within interaction features to determine when to discontinue interaction processing. Using the disclosed techniques, risk of issuer enumeration fraud may be reduced.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning and artificial intelligence, it should be understood that techniques according to this disclosure may be adapted to any suitable type of machine-learning and artificial intelligence. It should also be understood that the examples above are illustrative only. The techniques and technologies of this disclosure may be adapted to any suitable activity.

While financial applications and various aspects relating to finance (e.g., account management, payment processing, automation, and fraud detection) are described in the present aspects as illustrative examples, the present aspects are not limited to such examples. For example, the present aspects can be implemented for other types of fields, such as in any scenario related to optimizing data, predicting outcomes, and the like.

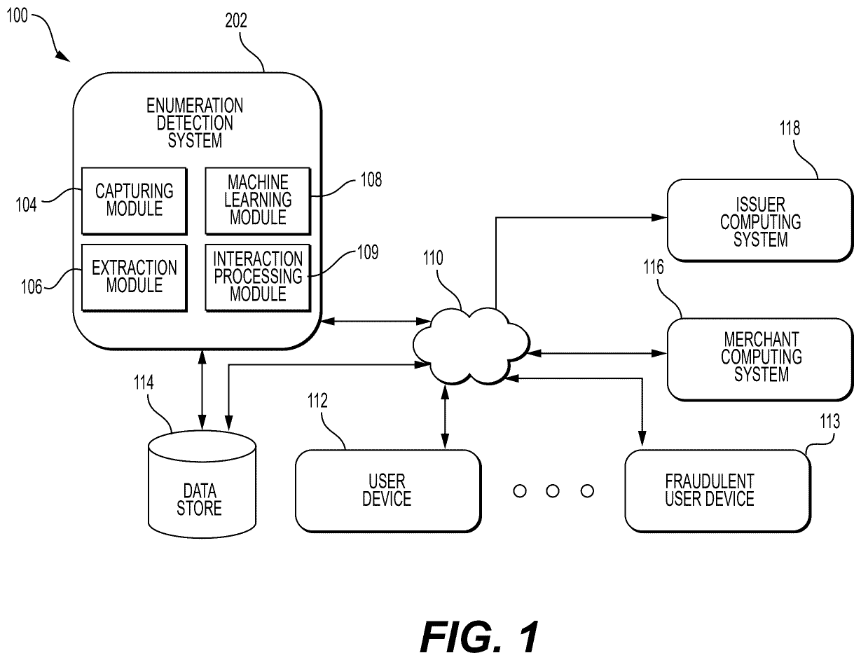

FIG. 1 depicts an exemplary environment 100 that may be utilized with techniques presented herein. One or more user device(s) 112 may communicate across an electronic network 110. The one or more user device(s) 112 may be associated with a user, e.g., a user that is managing or monitoring an account, a user that is associated with the account, an administrator of one or more components of environment 100, or the like. As will be discussed in further detail below, one or more enumeration detection system(s) 102 may communicate with one or more of the other components of the environment 100 across electronic network 110.

The user device(s) 112 may be configured to enable a user to access and/or interact with other systems in the environment 100. For example, the user device(s) 112 may each be a computer system such as, for example, a desktop computer, a mobile device, a tablet, etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of system control software, system monitoring software, software development tools, etc.

In various embodiments, the environment 100 may include a data store 114 (e.g., database). The data store 114 may include a server system and/or a data storage system such as computer-readable memory such as a hard drive, flash drive, disk, etc. In some embodiments, the data store 114 includes and/or interacts with an application programming interface for exchanging data to other systems, e.g., one or more of the other components of the environment. The data store 114 may include and/or act as a repository or source for storing data associated with a plurality of interaction instances, interaction features, input and/or output of the machine-learning or artificial intelligence models, generated reports, and the like (e.g., a user of user device 112 or any of the other components of environment 100).

In various embodiments, the environment 100 may include a merchant computing system 116. The merchant computing system 116 may include services, hardware, and software that enable merchants to accept and process credit card and debit card transactions (e.g. interactions) electronically. The merchant computing system 116 may be associated with one or more issuing banks, acquiring banks, credit card processors, and the like. The merchant computing system 116 may include various components such as payment gateways, inventory management tools, online reporting services, and payment processing terminals or readers. A merchant service provider and/or credit card processor may offer services implemented by merchant computing system 116 to business, allowing them to securely accept electronic payments from consumers and/or clients. A consumer may initiate an interaction using merchant computing system 116 by using their credit/debit card. Funds associated with the transaction may then be deposited from the consumer's bank account to a merchant's bank account associated with the merchant computing system 116. An account, associated with the merchant or the merchant computing system 116, may be monitored by enumeration detection system 102.

In various embodiments, the environment 100 may include an issuer computing system 118. The issuer enumeration detection system 118 may refer to the technology infrastructure and processes used by one or more financial institutions, such as banks, credit unions, and the like, to manage the issuance of credit and debit cards to consumers. The issuer computing system 118 may facilitate electronic payment interactions by providing cardholders with access to financial services and by enabling consumers to make purchases or initiate one or more interactions. Issuer computing system 118 may include card management and authorization systems, clearing and settlement processes, security measures, and fraud prevention capabilities. In examples, when a consumer may initiate an interaction using a credit or debit card, the interaction data may be sent to a card network, which may then be routed to the associated bank or financial institution through the issuer computing system 118. In various embodiments, the interaction data routed through issuer computing system 118 may be captured by enumeration detection system 102, such as by capturing module 104, as described in greater detail below.

In various embodiments, environment 100 may also include a fraudulent user device 113. In examples, the fraudulent user device 113, or associated components, may automate the process of generating payment card details, such as card numbers, expiry dates, CVV numbers, and the like. The generated, or guessed, payment card details may then be transmitted to the merchant computing system 116 in attempts to process fraudulent interactions. In various embodiments, automated tools or scripts may be run on the fraudulent user device 113 to rapidly submit a number of combinations of generated payment card details. In this way, the fraudulent user device 113 may enable cycling through a large number of permutations of generated payment card details. The fraudulent user device 113 may monitor responses from the merchant computing system 116 to identify valid payment card details based on factors such as error messages, response times, or the like.

In some embodiments, one or more components of the environment 100 are associated with a common entity, e.g., a corporate or financial institution, a service provider, an account provider, or the like. For example, in some embodiments, enumeration detection system 102 and data store 114 may be associated with a common entity. In some embodiments, one or more of the components of the environment is associated with a different entity than another. For example, merchant computing system 116 may be associated with a first entity (e.g., a retail store, card processor, or the like) while issuer computing system 118 may be associated with a second entity (e.g., a financial institution). The systems and devices of the environment 100 may communicate in any arrangement.

As depicted in FIG. 1, enumeration detection system(s) 102 may include capturing module 104. In various embodiments, capturing module 104 is configured to receive data associated with a plurality of interaction instances. The data may be received by enumeration detection system(s) 102 over network 110. In examples, real-time data associated with interaction instances may be captured by capturing module 104 from merchant computing system 116 (e.g., as a transaction is processed by merchant computing system 116 and/or from data retained by merchant computing system 116). Enumeration detection system(s) 102 may also include extraction module 106. In various embodiments, extraction module 106 may be configured to extract one or more interaction features from the data associated with the plurality of interaction instances. The interaction features may be stored in data store 114 and retrieved by components of enumeration detection system 102 for use.

As will be discussed herein, systems and/or devices of the environment 100 may communicate in order to one or more of generate, train, or use a machine-learning and/or artificial intelligence model to monitor transactions, among other activities. As discussed in further detail below, the enumeration detection system(s) 102 may one or more of (i) generate, store, train, or use a machine-learning model configured to identify enumeration patterns and detect fraudulent transactions. The enumeration detection system(s) 102 may include a machine-learning model and/or instructions associated with the machine-learning model, e.g., instructions for generating a machine-learning model, training the machine-learning model, using the machine-learning model etc. The enumeration detection system(s) 102 may include instructions for retrieving data, adjusting data, e.g., based on the output of the machine-learning model, and/or operating a display of the user device(s) 112 to output the results, e.g., as adjusted based on the machine-learning model. The enumeration detection system(s) 102 may include training data, e.g., data associated with interaction instances and/or interaction features, and may include ground truth, e.g., (i) training interaction instance data and (ii) training interaction feature data to generate the output.

As depicted in FIG. 1, enumeration detection system(s) 102 may also include machine-learning module 108 that may include and/or implement the machine-learning model. In some embodiments, a system or device other than the enumeration detection system(s) 102 is used to generate and/or train the machine-learning model. For example, such a system may include instructions for generating the machine-learning model, the training data and ground truth, and/or instructions for training the machine-learning model. A resulting trained-machine-learning model may then be provided to the enumeration detection system(s) 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations and/or identify patterns in interaction features and/or data associated with interaction instances such that the trained machine-learning model is configured to generate output results (e.g., a score, prediction, or the like).

In various embodiments, the variables of a machine-learning model may be interrelated in any suitable arrangement in order to generate the output. For example, in some embodiments, the machine-learning model may include data processing architecture that is configured to identify, isolate, and/or extract features in interaction instances. For example, the machine-learning model may include one or more convolutional neural network (“CNN”) configured to identify patterns in the interaction features, and may include further architecture, e.g., a connected layer, neural network, etc., configured to determine a relationship between the identified patterns in order to output an enumeration score, prediction, action to be taken, or to generate a report.

In some embodiments, the machine-learning model of the enumeration detection system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of interaction features and output an enumeration score, prediction, action to be taken, a report, or the like.

As depicted in FIG. 1, environment 100 may also include electronic network 110. In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in the environment 100 may, in some embodiments, be integrated with or incorporated into one or more other components. In another example, the enumeration detection system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to process data associated with interaction instances and/or interaction features are discussed in further detail in the methods below. In the following methods, various acts may be described as performed or executed by a component from FIG. 1, such as the enumeration detection system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

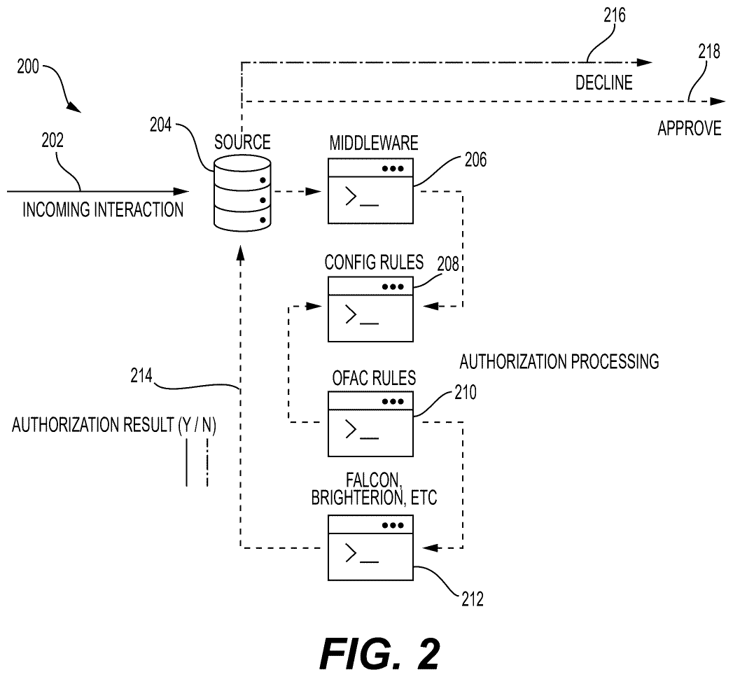

FIG. 2 illustrates a data flow diagram 200 of an exemplary enumeration detection system. As illustrated, an incoming interaction 202 may be received by source 204. In various embodiments, as part of authorization processing, interaction data from the incoming interaction 202 may be provided to middleware 206. Middleware 206 may verify or validate that incoming interaction 202 is authenticated (e.g., by verifying that data associated with incoming interaction 202 (e.g., interaction data) matches known data associated with a user(s) that may be associated with incoming interaction 202). Middleware 206 may also verify (e.g., authenticate) incoming interaction 202 by comparing the data associated with incoming interaction 202 to one or more sets of parameters (e.g., interaction processing rules, rules associated with a particular merchant account, or the like). In examples, such parameters may be set by an issuer computing system (such as issuer computing system 118, as depicted in FIG. 1), a merchant computing system (such as merchant computing system 116, as depicted in FIG. 1), a user device (such as user device 112, as depicted in FIG. 1), an enumeration detection system (such as enumeration detection system 102, as depicted in FIG. 1), or may be set by a user(s) associated with any of these components or systems. Middleware 206 may generate a verification determination based on comparing the data associated with incoming interaction 202 to the one or more sets of parameters.

In various embodiments, as part of authorization processing, interaction data from the incoming interaction 202, and the verification determination generated using middleware 206, may be provided to configuration rules 208. In examples, configuration rules 208 may include access control polices associated with the authorization processing, the merchant and/or issuer computing systems, the enumeration detection system, and the like. In various embodiments, configuration rules 208 may define access conditions based on user attributes, group memberships, and the like, and may define corresponding permissions based on the access conditions. In examples, the access conditions may further include rules (e.g., parameters) associated with the Office of Foreign Assets Control (OFAC) 210. In various implementations, as data from the incoming interaction 202 is analyzed or processed by configuration rules 208, the data may be compared to the access conditions to generate an access determination. In various embodiments, one or more machine-learning and/or artificial intelligence models may be used to identify patterns within large numbers of incoming interactions and the associated access determinations of each.

In implementations, and as part of authorization processing, the interaction data of the incoming interaction 202, may be provided to a machine-learning model 212. Machine-learning model 212 may be an artificial intelligence model in various implementations. In examples, the verification determination and/or the access determination may also be provided to machine-learning model 212. As will be described in greater detail below, machine-learning model 212 may be trained to identify enumeration patterns in features of the data of incoming interaction 202 and may output an enumeration score based on the identified enumeration patterns.

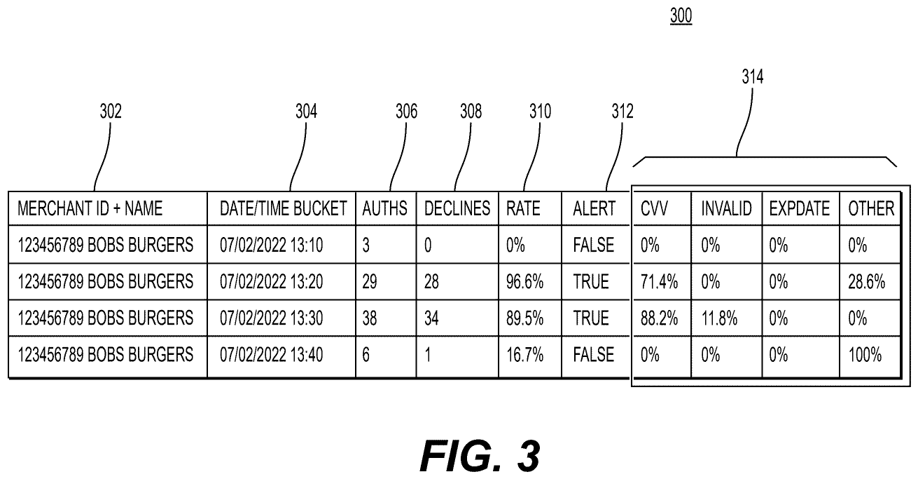

FIG. 3 illustrates a table 300 of exemplary data of a client interaction processing account. As illustrated, table 300 may represent an exemplary portion of data associated with a client interaction processing account. As illustrated in table 300, each row may represent one or more interactions with associated data (e.g., interaction data) and each column may represent an interaction feature of the interaction data. In various implementations, a merchant identifier and name 302 may be associated with the client interaction processing account. In examples, the merchant identifier and name 302 may be an interaction feature in common between multiple interactions associated with the same merchant. As illustrated, a date and time bucket 304 may be associated with each of the one or more interactions. In examples, the date and time bucket 304 may identify a period of time that the one or more interactions took place (e.g., were initiated or the like). A number of authorizations 306 may represent the number of interactions of the one or more interactions that were successfully authorized. A number of declines 308, therefore, may represent the number of interactions of the one or more interactions that were declined (e.g., due to a mismatch in debit/credit card information, or the like). In various implementations, a rate 310 may then be generated based on the number of authorizations 306 and the number of declines 308. In examples, the rate 310 may be an enumeration score output by a determinative machine-learning model. In such implementations, the rate 310 may be generated and output by a machine-learning model that may have been trained to identify enumeration patterns in the interaction features and output an enumeration score based on the identified enumeration patterns. In implementations, an alert flag 312 may be set based on the rate 310. In examples, interaction processing may be discontinued based on the alert flag 312 being set to true. As illustrated, rates associated with card information 314 may also be generated by the determinative machine-learning model.

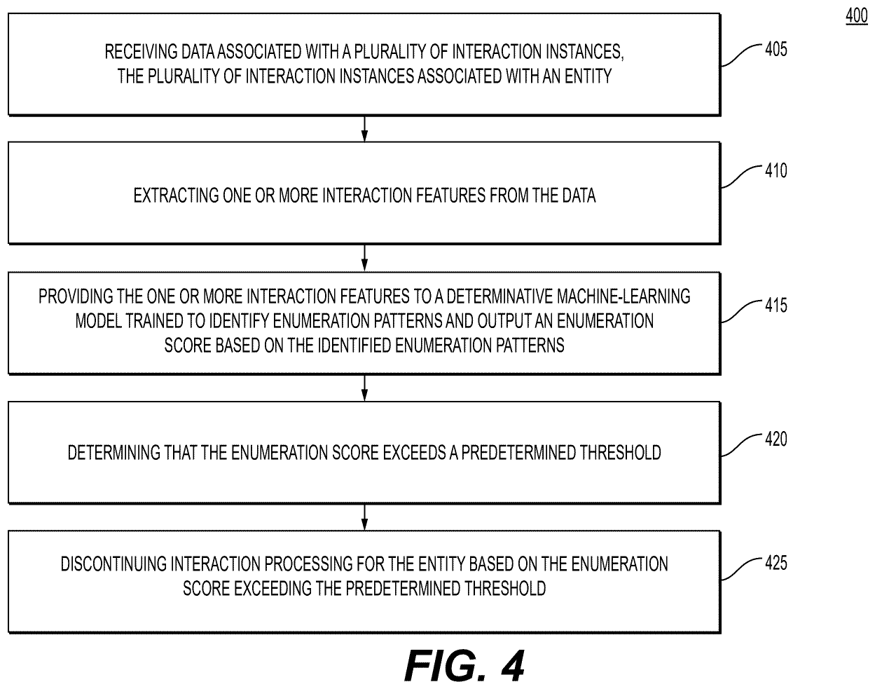

FIG. 4 illustrates an exemplary method 400 for discontinuing interaction processing using an enumeration detection system. At step 405, data associated with a plurality of interaction instances may be received. The data may be received in real-time (e.g., as the interaction is occurring, or the like). In examples, the data may be received by a capturing module of an enumeration detection system (such as capturing module 104, as depicted in FIG. 1). The plurality of interaction instances may be associated with an entity (e.g., a merchant, a user, a merchant computing system, a point of sale system, or the like). At step 410, one or more interaction features may be extracted from the data associated with the plurality of interaction instances. The one or more interaction features may be extracted using an extraction module of an enumeration detection system (such as extraction module 106, as depicted in FIG. 1). In examples, the interaction features may include numerical and/or textual data associated with the data, such as merchant and/or user identifiers, date and time identifiers, authorization or decline identifiers, debit/credit card information such as card number, expiry date, CCV, name, associated billing identifiers (e.g., address information), location data, or the like.

At step 415, the one or more interaction features may be provided to a determinative machine-learning model, such as the one or more machine-learning and/or artificial intelligence models described herein. The determinative machine-learning module may be implemented by a machine-learning module of an enumeration detection system (such as machine-learning module 108, as depicted in FIG. 1). In various embodiments, the determinative machine-learning model may have been trained to identify enumeration patterns within the one or more interaction features and output an enumeration score based on the identified enumeration patterns. In various implementations, the identified enumeration patterns and the enumeration score may be provided to the determinative machine-learning model as training data, and the determinative machine-learning model may be output, having been retrained using the identified enumeration patterns and the enumeration score.

At step 420, it may be determined that the output enumeration score exceeds a predetermined threshold. At step 425, interaction processing for the entity may be discontinued (or blocked) based on the enumeration score exceeding the predetermined threshold. Further, interaction processing may be flagged for the entity based on the discontinuing. In various implementations, an interaction authorization request associated with the entity may be received and, in response, an interaction result message may be transmitted that may include a decline code based on the enumeration score exceeding the predetermined threshold. In examples, steps 420 and 425 may be executed using an interaction processing module of an enumeration detection system (such as interaction processing module 109, as depicted in FIG. 1).

In a particular exemplary use case, an enumeration attack may be executed on an entity (e.g., a merchant, merchant computing system, or the like). The enumeration attack may include transmitting a large number of fraudulent attempts to process interactions with the entity, such as payment transactions, or the like. In such cases, the fraudulent attempts to process interactions may include mismatched information (e.g., card number and expiry date mismatch, and the like), or may include fraudulent submissions using otherwise valid payment credentials. Amongst the fraudulent attempts, the entity may also receive legitimate attempts to process interactions. Monitoring the merchant computing system, and differentiating between fraudulent and legitimate interactions, manually may be impossible due to the volume of incoming interactions, the reality of the rapid adaptations that may made to the fraudulent attempts using automation, and the like.

Therefore, in various implementations, as data from the interaction instances (e.g., fraudulent and valid) is received by a merchant computing system, an enumeration detection system may receive the data and extract interaction features from the data. The interaction features may be provided to one or more machine-learning models trained to identify patterns within the interaction features. Beyond determining an information mismatch between fraudulent interaction credentials and valid interaction credentials, the patterns identified by the one or more machine-learning models may relate to behaviors associated with the merchant computing system of the entity (e.g., number or type of interactions normally processed during a certain time of day, and the like). Therefore, the one or more machine-learning models may learn to utilize context in identifying patterns within the interaction features, allowing the one or more machine-learning models to leverage knowledge from pre-training to identify patterns in new datasets more efficiently than training the one or more machine-learning models from scratch as attacks become more sophisticated. In this way, the enumeration detection system may be enabled to detect enumeration attacks, perpetrated against numerous merchant entities, with a speed, precision, and adaptability not feasibly possible using manual methods. Further, upon detection of an enumeration attack, the enumeration detection system may be enabled to discontinue interaction processing for a merchant entity, automatically and in real-time, protecting the merchant entity from further exploitation.

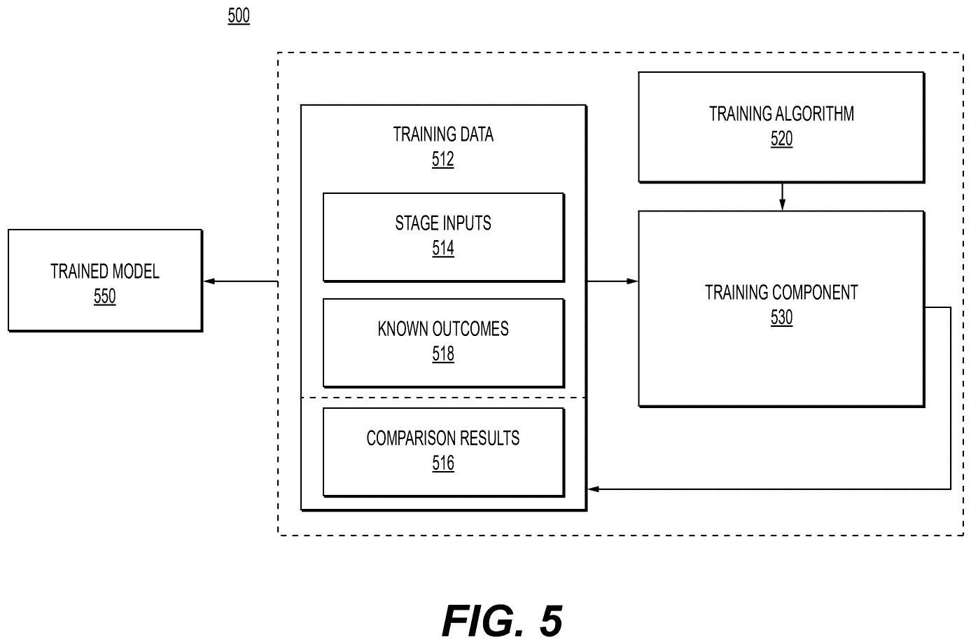

FIG. 5 depicts a flow diagram for training a machine-learning model. As shown in flow diagram 500 of FIG. 5, training data 512 may include one or more of stage inputs 514 and known outcomes 518 related to a machine-learning model to be trained. The stage inputs 514 may be from any applicable source including a component or set shown in the figures provided herein. The known outcomes 518 may be included for machine-learning models generated based on supervised or semi-supervised training. An unsupervised machine-learning model might not be trained using known outcomes 518. Known outcomes 518 may include known or desired outputs for future inputs similar to or in the same category as stage inputs 514 that do not have corresponding known outputs.

The training data 512 and a training algorithm 520 may be provided to a training component 530 that may apply the training data 512 to the training algorithm 520 to generate a trained machine-learning model 550. According to an implementation, the training component 530 may be provided comparison results 516 that compare a previous output of the corresponding machine-learning model to apply the previous result to re-train the machine-learning model. The comparison results 516 may be used by the training component 530 to update the corresponding machine-learning model. The training algorithm 520 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 500 may be a trained machine-learning model 550.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

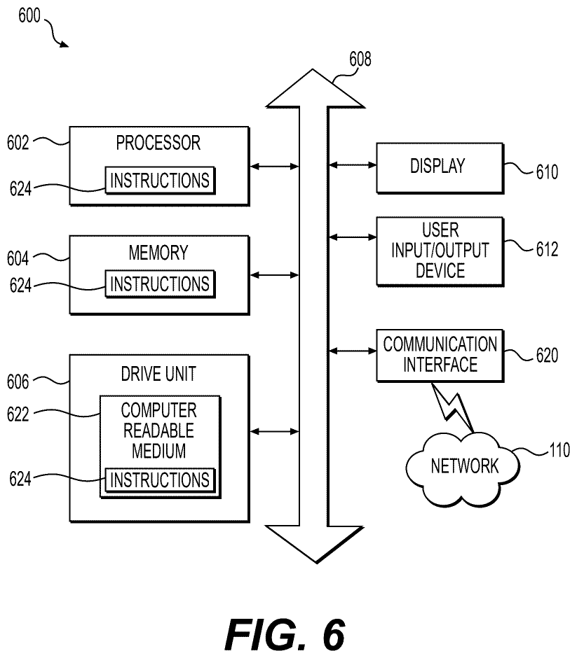

FIG. 6 is a simplified functional block diagram of a computer 600 that may be configured as a device for executing the methods disclosed here, according to exemplary aspects of the present disclosure. For example, the computer 600 may be configured as a system according to exemplary aspects of this disclosure. In various aspects, any of the systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications.

The computer 600 may also have a memory 604 (such as RAM) storing instructions 624 for executing techniques presented herein, for example the methods described with respect to FIG. 4, although the instructions 624 may be stored temporarily or permanently within other modules of computer 600 (e.g., processor 602 and/or computer readable medium 622). The computer 600 also may include input and output ports 612 and/or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for discontinuing interaction processing using an enumeration detection system, the method comprising:
receiving, by one or more processors, data associated with a plurality of interaction instances, the plurality of interaction instances associated with an entity;
extracting, by the one or more processors, one or more interaction features from the data;
providing, by the one or more processors, the one or more interaction features to a determinative machine-learning model trained to identify enumeration patterns and output an enumeration score based on the identified enumeration patterns;
determining, by the one or more processors, that the enumeration score exceeds a predetermined threshold; and
discontinuing, by the one or more processors, interaction processing for the entity based on the enumeration score exceeding the predetermined threshold.

2. The computer-implemented method of claim 1, wherein the one or more interaction features comprise numerical and/or textual data associated with the data.

3. The computer-implemented method of claim 1, wherein the data associated with the plurality of interaction instances is received in real-time.

4. The computer-implemented method of claim 1, further comprising:
providing, by the one or more processors, the identified enumeration patterns and the enumeration score to the determinative machine-learning model as training data; and
outputting, by the one or more processors, the determinative machine-learning model having been retrained using the identified enumeration patterns and the enumeration score.

5. The computer-implemented method of claim 1, further comprising flagging the interaction processing for the entity based on the discontinuing.

6. The computer-implemented method of claim 1, further comprising:
receiving, by the one or more processors, an interaction authorization request associated with the entity.

7. The computer-implemented method of claim 6, further comprising:
in response to the receiving, transmitting, by the one or more processors, an interaction result message including a decline code based on the enumeration score exceeding the predetermined threshold.

8. A system for discontinuing interaction processing, the system comprising:
a memory storing instructions and a determinative machine-learning model; and
a processor operatively connected to the memory and configured to execute the instructions to perform operations including:
receiving, by the processor, data associated with a plurality of interaction instances, the plurality of interaction instances associated with an entity;
extracting, by the processor, one or more interaction features from the data;
providing, by the processor, the one or more interaction features to the determinative machine-learning model trained to identify enumeration patterns and output an enumeration score based on the identified enumeration patterns;
determining, by the processor, that the enumeration score exceeds a predetermined threshold; and
discontinuing, by the processor, interaction processing for the entity based on the enumeration score exceeding the predetermined threshold.

9. The system of claim 8, wherein the one or more interaction features comprise numerical and/or textual data associated with the data.

10. The system of claim 8, wherein the data associated with the plurality of interaction instances is received in real-time.

11. The system of claim 8, the operations further comprising:
providing, by the processor, the identified enumeration patterns and the enumeration score to the determinative machine-learning model as training data; and
outputting, by the processor, the determinative machine-learning model having been retrained using the identified enumeration patterns and the enumeration score.

12. The system of claim 8, the operations further comprising flagging the interaction processing for the entity based on the discontinuing.

13. The system of claim 8, the operations further comprising:
receiving, by the processor, an interaction authorization request associated with the entity.

14. The system of claim 13, the operations further comprising:
in response to the receiving, transmitting, by the processor, an interaction result message including a decline code based on the enumeration score exceeding the predetermined threshold.

15. A non-transitory machine-readable medium storing instructions that, when executed by one or more processors, cause an enumeration detection system to perform a method for discontinuing interaction processing, the method comprising:
receiving, by the one or more processors, data associated with a plurality of interaction instances, the plurality of interaction instances associated with an entity;
extracting, by the one or more processors, one or more interaction features from the data;
providing, by the one or more processors, the one or more interaction features to a determinative machine-learning model trained to identify enumeration patterns and output an enumeration score based on the identified enumeration patterns;
determining, by the one or more processors, that the enumeration score exceeds a predetermined threshold; and
discontinuing, by the one or more processors, interaction processing for the entity based on the enumeration score exceeding the predetermined threshold.

16. The non-transitory machine-readable medium of claim 15, wherein the one or more interaction features comprise numerical and/or textual data associated with the data.

17. The non-transitory machine-readable medium of claim 15, wherein the data associated with the plurality of interaction instances is received in real-time.

18. The non-transitory machine-readable medium of claim 15, the method further comprising flagging the interaction processing for the entity based on the discontinuing.

19. The non-transitory machine-readable medium of claim 15, the method further comprising:
receiving, by the one or more processors, an interaction authorization request associated with the entity.

20. The non-transitory machine-readable medium of claim 19, the method further comprising:
in response to the receiving, transmitting, by the one or more processors, an interaction result message including a decline code based on the enumeration score exceeding the predetermined threshold.
